(19) United States
(12) Patent Application Publication
(10) Pub. No.: US 2017/0286507 A1
(43) Pub. Date: Oct. 5, 2017

(54) DATABASE SEARCH SYSTEM AND DATABASE SEARCH METHOD

(71) Applicant: Hitachi, Ltd., Tokyo (JP)

(72) Inventors: Koji HOSOGI, Tokyo (JP); Mitsuhiro OKADA, Tokyo (JP); Akifumi SUZUKI, Tokyo (JP); Shimpei NOMURA, Tokyo (JP); Kazuhisa FUJIMOTO, Tokyo (JP); Satoru WATANABE, Tokyo (JP); Yoshiki KUROKAWA, Tokyo (JP); Yoshitaka TSUJIMOTO, Tokyo (JP)

(73) Assignee: Hitachi, Ltd., Tokyo (JP)

(21) Appl. No.: 15/511,223

(22) PCT Filed: Jul. 22, 2015
(86) PCT No.: PCT/JP2015/070776

§ 371 Date: Mar. 14, 2017

(51) Int. Cl. G06F 17/30

(52) U.S. Cl. CPC G06F 17/30566; G06F 17/30979

(57) ABSTRACT

A database search system receives a command and searches for data, which meets a search condition specified on the basis of the received command, in a whole database which is a database as an entity. The database search system generates a virtual database which is a list of address pointers to the found data and stores the generated virtual database.

### TECHNICAL FIELD

The present invention generally relates to database processing, e.g., database search.

### BACKGROUND ART

Today, in concomitance with social media becoming increasingly widespread, and IT becoming utilized in a diversity of business circles such as finance, distribution, and communication, collected and accumulated amounts of data are also showing a rapid increase. In response to this, employing big data analysis has become a major trend, which enables comprehensive, integrated analysis of large-volume contents or a massive amount of data collected from sensors installed in a plant or the like. Typical examples where big data analysis is applied include trend prediction which is based on analysis of social media data, and stock management or failure prediction of equipment which are based on analysis of big data collected from industrial equipment or IT.

A system that performs such big data analysis generally includes a host server which performs the analysis and a storage which retains analysis target data. Database analysis which uses relational database is generally used for this analysis.

A database is generally made up of a 2-dimensional data array including columns indicating a generic name called a schema (or a label) and rows indicating actual data called an instance. A database operation is performed on this 2-dimensional database using a query language. A database search process is one of such database operations. This process involves, for example, searching such as extracting rows indicating a contents value of equal to or larger than 10,000, from a column with a schema “price”.

The following techniques can be employed to accelerate a database search process. For example, instead of a storage which uses a hard disk as a storage medium (for example, a storage system including a hard disk drive (HDD) or one or more HDDs), a storage which uses a nonvolatile semiconductor memory such as a flash memory as a storage medium (for example, a storage system including a solid state drive (SSD) or one or more SSDs) may be used as the storage in which databases are stored. Alternatively, a technique called an in-memory-type database may also be employed. Moreover, as disclosed in NPL 1 and NPL 2, a database search process may be accelerated by off-loading a database search process performed by a host server, to a storage. Furthermore, as disclosed in PTL 1, a Map-Reduction operation, which is one function of Hadoop (registered trademark), may be off-loaded to a storage.

### CITATION LIST

### Patent Literature

[PTL 1]

U.S. Pat. No. 8,819,335

### Non-Patent Literature

[NPL 1]

“Fast, Energy Efficient Scan inside Flash Memory SSDs”, ADMS (2011) [NPL 2]

Ibex: “An Intelligent Storage Engine with Support for Advantage SQL Offloading”, VLDB, Volume 7 Issue 11, July 2014

### SUMMARY OF INVENTION

### Technical Problem

In big data analysis, important data or valuable data are usually detected first from a large-volume database, and the thus detected data having a small volume is subjected to an analysis process such as data mining or clustering. In the first data detection process, an analyzer performs data search while changing search conditions, e.g. adding keywords or adjusting thresholds, and thus makes various attempts until the volume of the data detected (search result) becomes small. In such an analysis process, a search process must be performed repeatedly for a large-volume database. Moreover, in a series of search processes, it is necessary to repeatedly perform full search on the entire volume of the database. The full search requires searching on all rows of the database, resulting in the processing amount becoming considerably large.

As a method for solving this problem, snapshot data made up of not more than a certain amount of search results (data acquired from the database) may conceivably be stored as a new database. Here, by searching the new small-volume database in the subsequent processes, the processing amount of search could be reduced, thereby reducing the time taken for search.

However, this method requires an additional storage volume for storing a new database (snapshot data) which overlaps a portion of the original database, in addition to the original database. Due to this, a problem is newly created in terms of the storage volume of a storage having to be increased. In big data analysis, the data volume of the snapshot data itself, generated during the search processes, is considered to be large as well.

The above-mentioned problems may also occur in database search other than that for big data analysis.

### Solution to Problem

A database search system receives a command and searches for data that meets a search condition, specified on the basis of the received command, from a whole database which is a database serving as an entity. The database search system generates a virtual database which is a list of address pointers to the found data and stores the generated virtual database.

### Advantageous Effects of Invention

It is possible to reduce the search processing amount of the second and subsequent search processes by creating a database using a search result, and to reduce the added data amount even when the database is created using the search result.

### BRIEF DESCRIPTION OF DRAWINGS

FIG. 1 illustrates a configuration example of a database search system.

FIG. 2 illustrates an example of the relation between LBA and PBA and an example of an address conversion method.

FIG. 3 illustrates an example of a table included in a database.

FIG. 4 illustrates an example of a search instruction query.

FIG. 5 illustrates an example of the relation between a virtual DB allocation mode and a storage format of an address pointer list.

FIG. 6 illustrates a configuration example of a DB search accelerator.

FIG. 7 illustrates a configuration example of constituent elements included in DB search accelerator management information.

FIG. 8 illustrates an example of the relation between constituent elements of DB search accelerator management information.

FIG. 9 illustrates a configuration example of a DB pointer control unit.

FIG. 10 illustrates a configuration example of a first data buffer.

FIG. 11 illustrates a configuration example of a DB search engine.

FIG. 12 illustrates an example of an operation flow of a first table control unit.

FIG. 13 illustrates an example of an operation flow of a second table control unit.

FIG. 14 illustrates a configuration example of a DB operation accelerator.

FIG. 15 illustrates a configuration example of an address pointer generator.

FIG. 16 illustrates an example of the control of an address pointer generator.

FIG. 17 illustrates the concept of examples of DB operation commands.

FIG. 18 illustrates examples of basic IO commands from a host server to a storage.

FIG. 19 illustrates examples of commands that define and acquire the structure and the state of a database.

FIG. 20 illustrates examples of commands related to database search.

FIG. 21 illustrates examples of operation commands of a virtual DB.

### DESCRIPTION OF EMBODIMENT

Hereinafter, several embodiments will be described with reference to the drawings.

In the following description, although information is sometimes described using an example of a “xxx management table,” the information may be expressed by any data structure. That is, the “xxx management table” can be referred to as “xxx management information” in order to indicate that the information does not depend on the data structure. Moreover, in the following description, one management table may be divided into two or more management tables, and all or apart of two or more management tables may constitute one management table.

In the following description, when the same types of elements are not distinguished from each other, a common number in the reference numerals is used (for example, an address pointer list 581), and when the same types of elements are distinguished from each other, reference numerals are used (for example, address pointer lists 581A, 581B, . . . ).

In the following description, a “database” is appropriately abbreviated as a “DB”. Moreover, in the following description, a table as management information is referred to as a “management table,” and a DB table (a table as a constituent element of a DB) is referred to simply as a “table”.

In the following description, although a “bbb unit” (or a bbb accelerator) is used as a subject, a processor may be used as a subject since these functional units can perform predetermined processes using a memory and a communication port (a network I/F) by being executed by the processor. A processor typically includes a microprocessor (for example, a central processing unit (CPU)), and may further include dedicated hardware (for example, an application specific integrated circuit (ASIC)) or a field-programmable gate array (FPGA). Moreover, processes started using these functional units as a subject maybe processes performed by a storage or a host server. Moreover, all or a part of these functional units may be implemented by dedicated hardware. Moreover, various functional units may be installed in respective computers by a program distribution server or a storage medium readable by a computer. Moreover, various functional units and servers may be installed in one computer and may be installed in a plurality of computers. A processor is an example of a control unit and may include a hardware circuit that performs all or a part of processes. A program may be installed in an apparatus such as a computer from a program source. The program source may be a program distribution server or a storage medium readable by a computer. When the program source is a program distribution server, the program distribution server may include a processor (for example, a CPU) and a storage unit, and the storage unit may store a distribution program and a distribution target program. The processor of the program distribution server may execute a distribution program whereby the processor of the program distribution server distributes a distribution target program to another computer. Moreover, in the following description, two or more programs may be implemented as one program, and one program may implement two or more programs.

In the following description, a “storage unit” may be one or more storage devices including a memory. For example, the storage unit may be at least a main storage device among a main storage device (typically a volatile memory) and an auxiliary storage device (typically a nonvolatile main storage device).

An embodiment will be described based on the drawings.

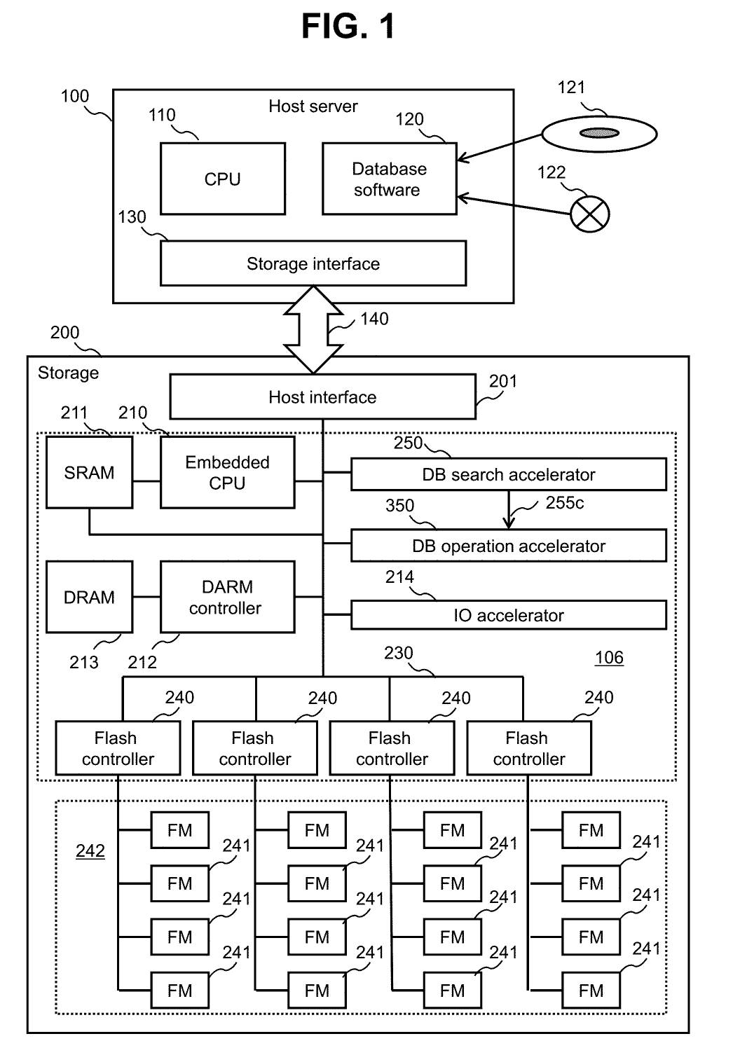

FIG. 1 illustrates a configuration example of a database search system.

The database search system includes at least one of a host server 100 and a storage 200. The host server 100 and the storage 200 are coupled by a host bus 140. A communication network such as the Internet 122 or a local area network (LAN) may be employed instead of the host bus 140.

The host server 100 is an example of a host system and may be one or more computers. The host server 100 includes a storage unit (not illustrated) that stores a program such as database software 120, a CPU 110 that executes a program such as the database software 120, and a storage interface 130 which is an interface that couples to the storage 200. The database software 120 may be input from a storage medium (for example, a magnetic medium) 121 or a server on the communication network (for example, the Internet) 122. The CPU 110 is an example of a processor.

The storage 200 in the present embodiment is a storage device which uses a flash memory 242 including one or more flash memory chips (FMs) 241 as a storage medium. However, other types of storage media (for example, other semiconductor memories) maybe employed as the storage medium instead of or in addition to the flash memory 242. Moreover, the storage 200 may be a storage system including a plurality of storage devices. The plurality of storage devices may form one or more redundant array of independent (or inexpensive) disks (RAID) groups. Each storage device in the RAID group may be a HDD and may be a storage device (for example, a SSD) which uses the flash memory 242 as a storage medium.

The storage 200 includes a host interface 201 that receives a command from the host server 100 and a storage controller 106 that performs IO-accesses to the flash memory 242 as necessary in processing of the request received by the host interface 201. The storage controller 106 is an example of a controller of a database search system. The respective constituent elements in the host interface 201 or the storage controller 106 are communicably coupled via an internal bus 230 of the storage 200.

The host interface 201 is an interface that couples to the host server 100 via the host bus 140.

The constituent elements of the storage controller 106 include, for example, a built-in CPU 210 that controls the entire storage 200, a static random access memory (SRAM) 211 used as a cache memory or a local memory of the built-in CPU 210, a dynamic random access memory (DRAM) 213 that temporarily stores firmware for controlling the storage 200 and the address or the data for an IO access issued from the host server 100, a DRAM controller 212 that controls the DRAM 213, a flash controller 240 that controls the FM 241, a DB search accelerator 250 that performs a portion (particularly, database search) of a database process executed by the host server 100, a DB operation accelerator 350 that assists an operation of a virtual DB (a virtual database) to be described later, and an IO accelerator 214 that improves the performance of an access to the flash memory 242. At least one of the accelerators 250, 350, and 214 is hardware. The IO accelerator 214 is an accelerator that has a function of assisting a portion of the process of the built-in CPU 210 and improves the performance of an IO access to the flash memory 242. While the DRAM 213 retains firmware and IO data in the present embodiment, the DRAM 213 in actual practice may retain various items of information for controlling the storage 200, and the information retained in the DRAM 213 may not be limited. At least one of the DRAM 213 and the SRAM 211 is an example of a storage unit. Moreover, other types of storage media may be employed instead of or in addition to at least one of the DRAM 213 and the SRAM 211, and the storage unit may include other types of storage media. The built-in CPU 210 is an example of a processor.

A plurality of FMs 241 is coupled to one flash controller 240. A plurality of flash controllers 240 access the plurality of FMs 241 in parallel. One flash controller 240 and the plurality of FMs 241 form one set, and these sets are arranged in parallel. Asa result, the FMs 241 are arranged in an array form. Since the plurality of flash controllers 240 can access these FMs 241 arranged in the array form in parallel, the overall throughput of the storage 200 is improved.

Here, the feature of the FM 241 will be described. In the present embodiment, the FM 241 is a NAND-type FM. Thus, data is written to the FM 241 in units of pages (typically in kilobyte order). Moreover, since the NAND-type FM 241 is a non-rewritable storage element, data is erased in units of blocks (typically in megabyte order), and then, data can be written to pages in the block. The FM 241 includes a plurality of blocks, and each block includes a plurality of pages. Furthermore, sequential write is used when writing data to blocks for the perspective of data reliability. Moreover, random write mainly in units of bytes to megabytes, for example, is used when writing data to the storage 200. Therefore, writing of data to the FM 241 is controlled by correspondence between a logical address designated by the host server 100 and a physical address (the physical address to pages of the FM 241) in the storage 200. Hereinafter, a logical block address (LBA) is employed as an example of the logical address, and a physical block address (PBA) is employed as an example of the physical address.

As described above, in the present embodiment, a portion (for example, a search process) of the database process is offloaded to the storage 200. However, the present invention is not limited to such a configuration. All database processes may be performed by the host server 100 and may be performed by the storage 200. In the former case, the database software 120 in the host server 100 is a database management system (DBMS) and may receive a query such as a search instruction query from a query issuing source (for example, a client system (not illustrated) or an application program different from the database software 120) and issue an input/output (IO) request (that is, a write request or a read request) to the storage 200 according to the query. In the latter case, a DBMS in the storage 200 may receive a query such as a search instruction query from a query issuing source and perform IO access to the flash memory 242 according to the query. When the DBMS is implemented at least in the storage 200, at least a portion of the DBMS may be implemented by hardware such as the DB search accelerator 250.

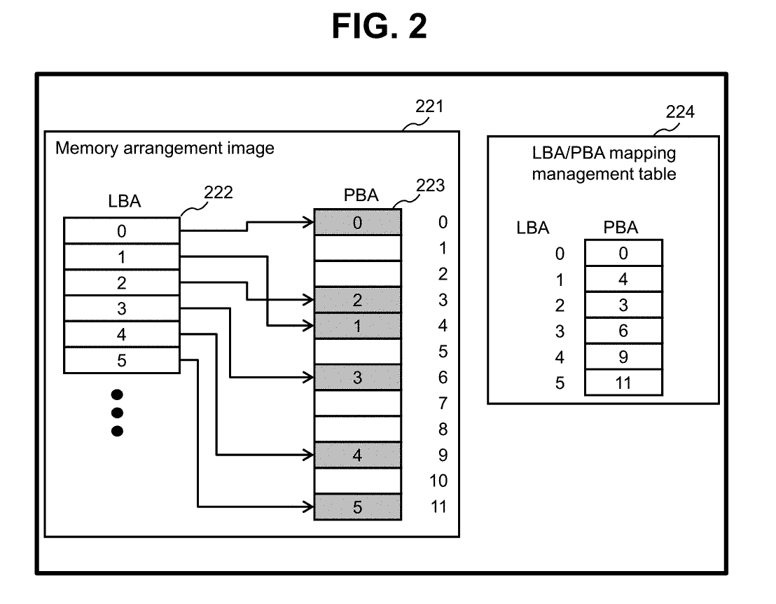

FIG. 2 illustrates an example of the relation between LBA and PBA and an example of an address conversion method.

As illustrated in a memory arrangement image 221, a LBA space 222 accessed by the host server 100 is a group of successive LBAs, and similarly, a PBA space 223 in the storage 200 is a group of successive PBAs. Different items of data of which the write destination is the same LBA are not stored in the same PBA area (page) , and different PBAs are allocated to different LBAs. Therefore, for example, when PBA4 is allocated to LBA1, PBA4 is not allocated to different LBA2. In order to recognize this, a LBA/PBA mapping management table 224 is used. The LBA/PBA mapping management table 224 is a management table representing the correlation between LBA and PBA, and is stored in the SRAM 211, for example, so as to be referred to by the built-in CPU 210. By using the LBA/PBA mapping management table 224, it is possible to convert addresses from LBA to PBA, and it is possible to recognize a storage location corresponding to a designated LBA. Here, since the LBAs are successive, the mapping management table 224 does not need to retain the LBA and PBA pairs but actually needs to retain PBA only.

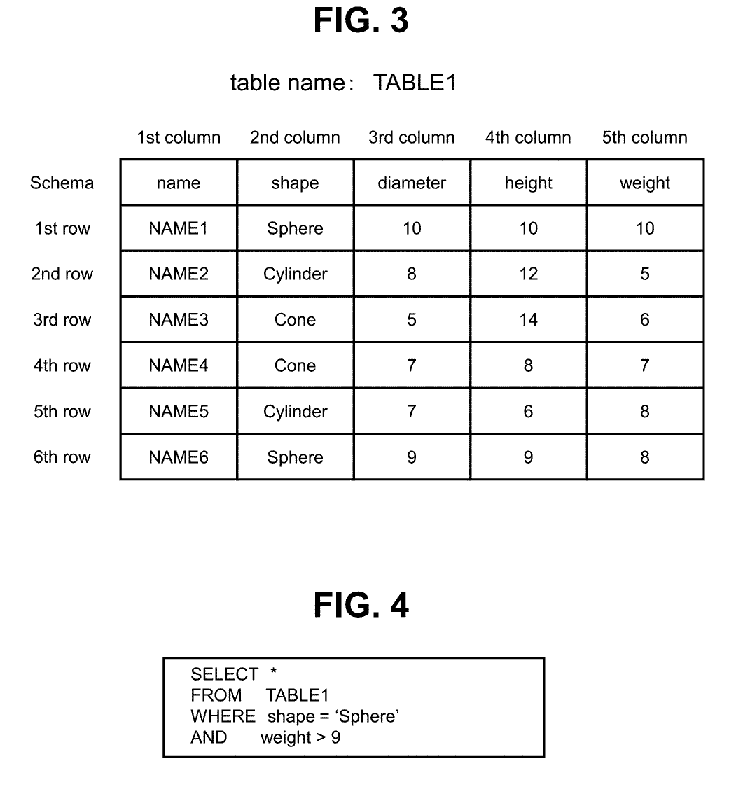

Next, an example of a database process will be described with reference to FIGS. 3 and 4.

FIG. 3 illustrates an example of a table included in a database.

As illustrated in FIG. 3, a database has a 2-dimensional data structure in which columns are arranged in a horizontal direction and rows are arranged in a vertical direction. The top stage is referred to schema and means the label of each column. The row direction is contents of each schema and can be defined by various data widths such as a character string or a numerical value. For example, in this example, a contents value of the “height” schema of which the “name” schema is “NAME1” is “10”. Moreover, a table name of this database is defined as the name TABLE1. Meta information such as a schema name, the number of schemas, and a data width and a table name of each schema is defined in advance by structured query language (SQL) of whole database language. Moreover, a data amount per row is determined by the definition of the data width of each schema. In the present embodiment, it is assumed that the data amount per row is 256 bytes.

FIG. 4 illustrates an example of a search instruction query.

This query has the SQL format of whole database language. The character string SELECT on the first row indicates an output format and the wildcard (*) indicates the entire row. When a schema name (for example, “diameter”) is designated instead of the wildcard, the value of the schema is output. The character string FROM on the second row indicates a table name and indicates that a database of which the table name is TABLE1 is a target database. The character string WHERE on the third row indicates a search condition and indicates that rows of which the schema name “shape” is “Sphere” are search targets. Moreover, the character string “AND” on the fourth row is an additional condition of WHERE on the third row and indicates that rows of which the schema name “weight” is larger than the value “9” are search targets. When this search instruction query is executed on the database TABLE1 defined in FIG. 3, data on the first row which is a row of which “shape” is “Sphere” and “weight” is larger than the value “9” is output. The database process of the present embodiment relates to a process of narrowing a search target while interactively adding a search instruction query a plurality of number of times and is used in a process of extracting valid data in big data analysis. Hereinafter, this database search example will be described.

Next, a command serving as a control target of the present embodiment will be described with reference to FIGS. 18 to 20. The command illustrated below is a command that the host server 100 issues to the storage 200, and the storage 200 executes a process corresponding to the command. The opcode used in the drawings indicates the type of a command, the operand indicates parameters necessary for the command, and the return value indicates a return value returned from the storage 200 for the command. These commands may use a normal interface via which the host server 100 transmits all items of information to the storage 200 or an interface which uses a doorbell used in the Non-Volatile Memory express (NVMe) standard. In the interface which uses a doorbell, the host server 100 indicates an address pointer in which a portion of an opcode and an operand and the main body of the operand are stored and the storage 200 having received a command can recognize the operand by independently reading data from a memory area indicated by the address pointer. Similarly, as for the return value, the main body of the return data may be returned to the host server 100, and the return value may be retained in a storage area in the storage 200 and the host server 100 may read the same via a doorbell interface. Moreover, the command type, the operand, the opcode, and the return value illustrated in the drawings illustrate minimum items of information only necessary for describing the present embodiment, and expansion of these items of information is not limited.

FIG. 18 illustrates examples of basic IO commands from the host server 100 to the storage 200.

A memory write instruction command is a normal IO write from the host server 100 to the storage 200. The host server 100 transfers an amount of data corresponding to a write data amount from a base address to the storage 200. The storage 200 stores the data in the internal flash memory 242. In this instance, the built-in CPU 210 reserves a physical area in the flash memory 242 and writes write target data to the reserved physical area. In this instance, the LBA/PBA mapping management table 224 is updated for the address conversion described with reference to FIG. 2.

A memory read instruction command is a normal IO read command to return data of the storage 200 to the host server 100. Data corresponding to a read data amount from a base address is returned.

A trim instruction command is a command to invalidate an amount of data corresponding to a trim data amount from a base address. The storage 200 which uses the flash memory 242 may have a larger physical volume than a logical volume. Therefore, with an increase in the amount of data used in the storage 200, it is necessary to perform a defragmentation process for creating a vacant area in the physical volume of the storage 200. Here, the vacant volume of the physical volume is large, since the degree of freedom of the defragmentation process which is executed on the background increases, the performance increases. This trim instruction command is a command for actively increasing the vacant volume.

A remaining physical volume acquisition command is a command for returning an allocatable physical volume value and a largest value of the physical volume of successively allocatable vacant areas to the host server 100. An application on the host server 100 can know a newly allocatable physical volume from the returned value.

The memory write instruction command, the memory read instruction command, and the remaining physical volume acquisition command are commands that involve data transfer, and data transfer which uses a doorbell can be used in this data transfer.

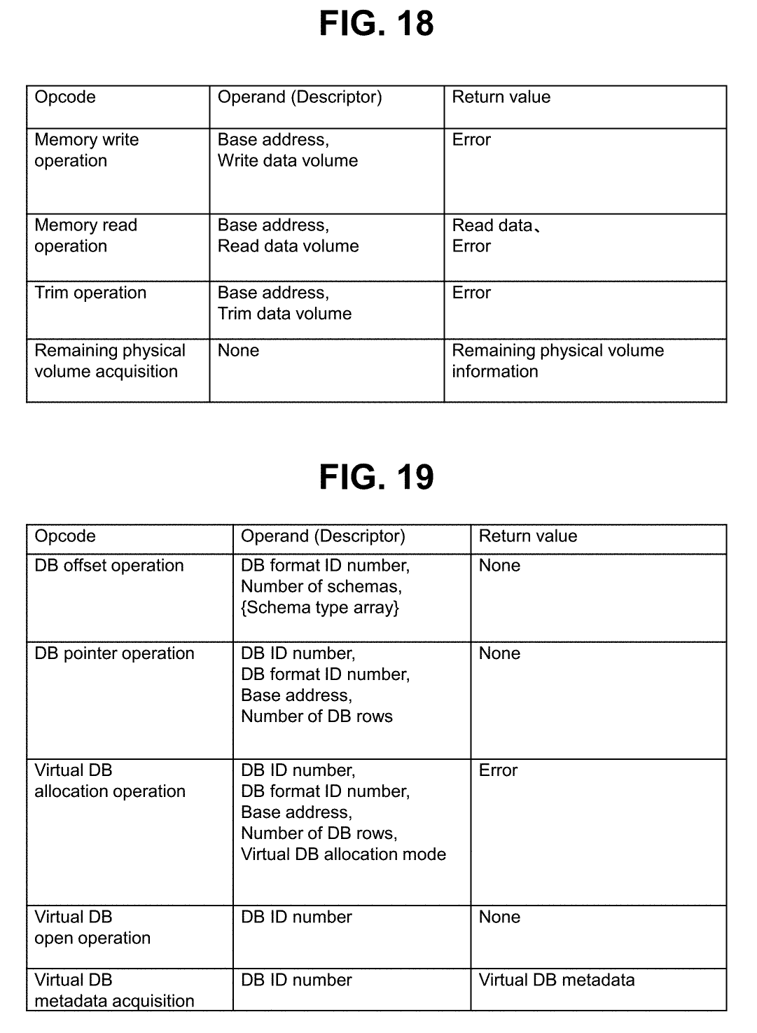

FIG. 19 illustrates examples of commands that define and acquire the state and the state of a database.

The group of commands illustrated in FIG. 19 is defined as a special command from the host server 100 to the storage 200.

A DB format instruction command is a command that defines the format of a DB table. For example, the DB table defined in FIG. 3 can be defined by the number of schemas of 5 and the data width (schema type) of each schema. Moreover, although the table name is TABLE1, the structure of TABLE1 defined in FIG. 3 can be defined by digitizing the table name as a DB format identification number (for example, “1”) and correlating both. A plurality of values are inserted in the parentheses “{“ and ”}” present before and after the schema type in order to correspond to a plurality of number of schemas. Moreover, the order of these values is identical or similar to the column direction. This DB format is identical or similar to the format of the CREATE statement in the SQL language used in a whole database.

A DB pointer instruction command indicates a command that defines an entity area of a DB indicated by a DB format recognition number, defined by the DB format instruction command and is a command to allocate the entity area of a database area to the storage 200 using a physical base address and the number of DB rows. A DB identification number is assigned to correlate this entity area.

The DB format instruction command and the DB pointer instruction commands are commands for expressing the format of a DB defined by the SQL of a whole database language.

A virtual DB allocation instruction command is a command to allocate a virtual DB to the storage 200. The DB identification number illustrated in the operand is an identification number for identifying the allocated virtual DB. The DB format identification number means allocation of a virtual DB having the structure of the DB format defined by the DB format instruction command. The base address indicates a starting LBA to which the virtual DB is allocated. The number of DB rows indicates the number of rows of the virtual DB. Here, the “virtual DB” is not a DB contents entity (for example, a group of items of data that form a DB table or a portion thereof) of a database but is a list of address pointers to the DB contents entity of the database. A plurality of representation methods (storage formats) of the address pointer list is present, and the storage format of the address pointer list is uniquely determined by a virtual DB allocation mode to be described later. p The DB open instruction command is a command to open an entity area of the virtual DB indicated by the DB identification number. Specifically, the DB open instruction command invalidates the virtual DB indicated by the DB identification number instead of the base address and the data volume similarly to the trim instruction command to the virtual DB. Moreover, a virtual DB metadata acquisition command is a command to return metadata such as the state of a virtual DB indicated by the DB identification number to the host server 100.

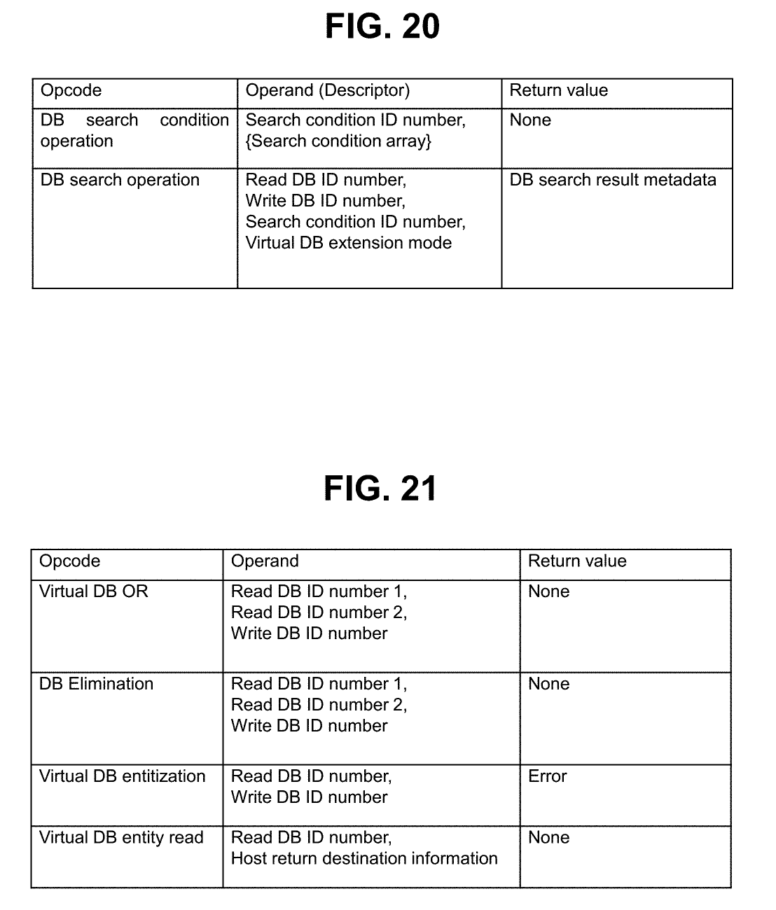

FIG. 20 illustrates examples of commands related to database search.

The database search means the database search example illustrated in FIG. 4. The commands illustrated in FIG. 20 maybe commands from the host server 100 to the storage 200, for example, and may be commands (for example, commands generated by the built-in CPU 210) generated inside the storage 200 based on a command from the host server 100.

A DB search condition instruction command is a command that indicates a DB search condition. In the example of FIG. 4, a plurality of search conditions that the data on the second column is “Sphere” and the data on the fifth column is larger than “9”. Therefore, a plurality of search conditions can be designated as a search condition array. Moreover, this search condition array is correlated as a search condition identification number.

The DB search instruction command is a command to perform search with respect to a DB indicated by a read DB identification number according to a search condition indicated by the search condition identification number and sequentially add an address pointer of a DB row that meets the search condition to the virtual DB indicated by a DB identification number. With this command, a group of address pointers to hit DB rows only in the DB search can be acquired. Here, the DB indicated by the read DB identification number may be either a whole DB or a virtual DB. The “whole DB” is the above-described database (a database as an entity).

The information that is returned from the storage 200 to the host server 100 as the return value of the DB search instruction command includes metadata indicating an outline of a DB search result. The metadata includes the number of hit DB rows. The host server 100 can recognize the data volume of the DB search result on the basis of the number of hit DB rows. Here, when the virtual DB extension mode is a normal mode and the virtual DB that stores the search result is larger than the number of DB rows designated by the virtual DB allocation instruction command, the search ends and a buffer overflow state is returned as the metadata. Upon recognizing the buffer overflow state, the host server 100 can recognize that search does not end sufficiently because the search condition is obscure in this DB search instruction command. Moreover, when the virtual DB extension mode is an extension mode, the search does not end if the data volume of the DB search result is equal to or smaller than the remaining physical volume, the number of DB rows of the virtual DB indicated by the DB identification number is updated.

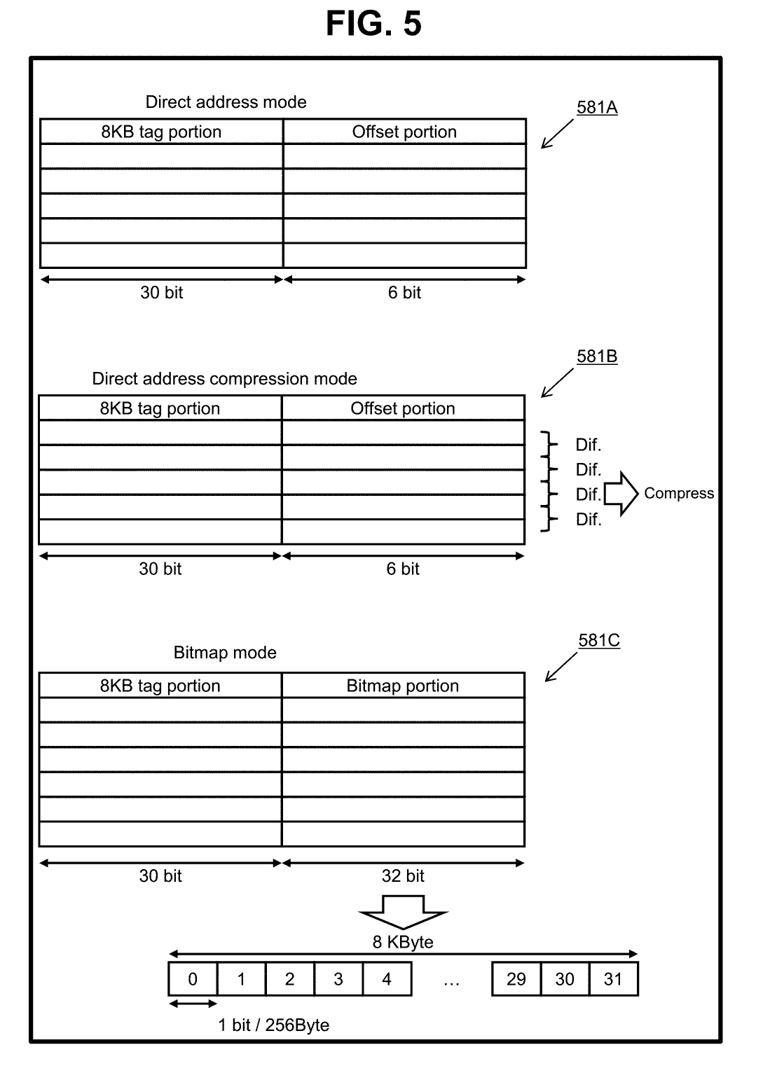

FIG. 5 illustrates an example of the relation between a virtual DB allocation mode and a storage format of an address pointer list.

The virtual DB allocation mode comes in three types. In the embodiment, at least two types of virtual DB allocation modes may be selected from three types of virtual DB allocation modes. The virtual DB allocation mode may be designated by a search command 303 (the mode may be designated whenever search is performed) , and a virtual DB allocation mode selected from a user (for example, the user of the host server 100 or a management system (not illustrated)) as a virtual DB allocation mode common to a plurality of search processes may be designated from the host server 100 or the management system to the storage 200. Information indicating the designated type of the virtual DB allocation mode may be stored in a storage unit of the storage controller 106, and the storage format of the virtual DB (an address pointer list 581) may be determined according to the information.

The storage format of the address pointer list 581 is different as indicated by reference numerals 581A to 581C depending on the mode designated as the virtual DB allocation mode. In the description of the present embodiment, it is assumed that a storage volume (a total storage volume of the FM 241) of the flash memory 242 in the storage 200 is 8 TB and the volume of each row of a database is 256B as illustrated in the description of FIG. 3.

When a direct address mode is designated as the virtual DB allocation mode, the address pointer list 581A is employed. In the direct address mode, the address pointer list 581A is configured to include an 8KB tag portion having the width of 30 bits that retains an address tag of 8KB and an offset portion having the width of 6 bits. Since 2³⁰ items of 8 KB data are present in the total storage volume of 8 TB, the 8 KB tag portion having the width of 30 bits can manage addresses in units of 8 KB. Moreover, since 2³ items of 256B data are present in 8 KB, the offset is set to 6 bits. Using the total 36-bit addresses made up of the 8 KB tag portion having the width of 30 bits and the offset portion having the width of 6 bits, it is possible to manage the locations of 256 B row data in the 8 TB flash memory 242. As described above, since one address is allocated directly to one row of data, this mode is referred to as a “direct address mode” in the present embodiment.

When a direct address compression mode is designated as the virtual DB allocation mode, the address pointer list 581B is employed. The direct address compression mode is basically identical or similar to the direct address mode. Here, in the address pointer list 581B, when address pointers are normalized in ascending or descending order, the difference between the addresses of preceding and subsequent rows is smaller than an address pointer having the width of 36 bits. Particularly, when a total number of rows retained by the address pointer list 581B (the virtual DB) is large, the absolute value of this difference value approaches “0”. In such a sequence of numbers in which a change in values is small and a binary representation in which the unevenness in the bit values “0” and “1” is large, the compression ratio of the data is large. Therefore, in the direct address compression mode, it is possible to reduce the volume of the virtual DB by compressing the virtual DB using the initial value of the virtual DB and the subsequent difference values.

When a bitmap mode is designated as the virtual DB allocation mode, the address pointer list 581C is employed. The 8 KB tag portion in the bitmap mode is equivalent to that of other modes. On the other hand, a bitmap portion having the width of 32 bits is used instead of the offset portion having the width of 6 bits. That is, 8 KB data is made up of 2⁵ items of 256B data (that is, 32 items of data), and “1” is set when a target row is present and “0” is set when a target row is not present. For example, when 32 successive DB rows having the width of 256B are managed as a virtual DB, the virtual DB can be represented by one 8 KB tag portion and the 32-bit bitmap portion. Although an information amount of 1152 bits (=32×(30+6)) is required in the direct address mode, the bitmap portion can be represented by an information amount of 62 bits (=1×(30+32)) in the bitmap mode, and the data amount can be compressed by the ratio of 0.053. The data amount in the direct address compression mode is between those of the direct address mode and the bitmap mode.

In the bitmap mode, the data volume can be reduced by compressing the 8 KB tag portion particularly.

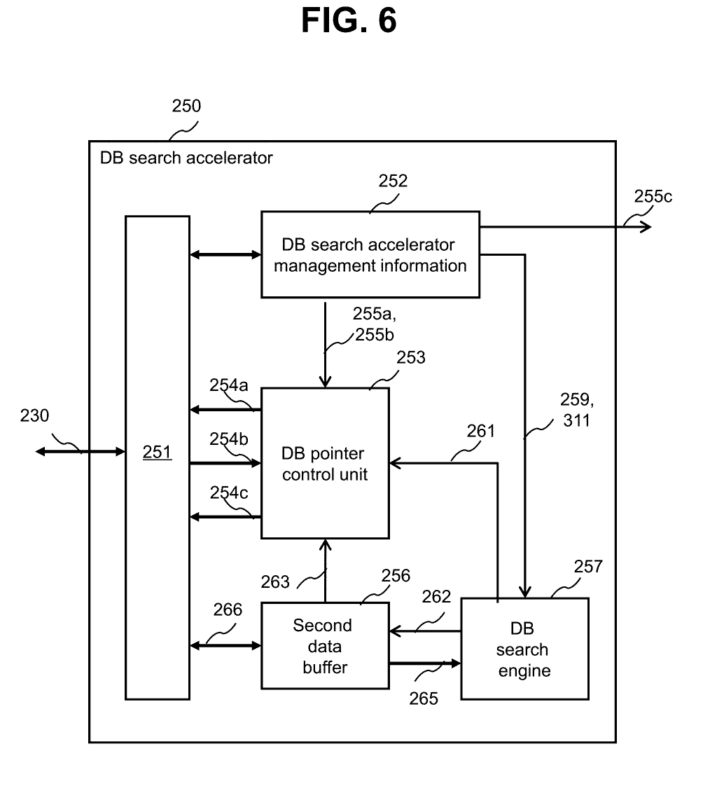

FIG. 6 illustrates a configuration example of the DB search accelerator 250.

The DB search accelerator 250 includes a first internal bus interface 251, DB search accelerator management information 252, a DB pointer control unit 253, a first data buffer 256, and a DB search engine 257.

The first internal bus interface 251 is coupled to the internal bus 230. The first internal bus interface 251 is information illustrating a processing content for activating and executing the DB search accelerator 250. The DB pointer control unit 253 indicates the location information of a database. The first data buffer 256 stores a portion of the data (hereinafter referred to as DB source data) of the database. The DB search engine 257 performs a database search process on the DB source data stored in the first data buffer 256 using a search condition 259 output by the DB search accelerator management information 252 as an input and outputs search hit information 261 to the DB pointer control unit 253 when the search condition is satisfied.

The DB search accelerator management information 252, the DB pointer control unit 253, and the first data buffer 256 are coupled to the first internal bus interface 251. The DB search engine 257 can communicate with the DB search accelerator management information 252, the DB pointer control unit 253, and the first data buffer 256.

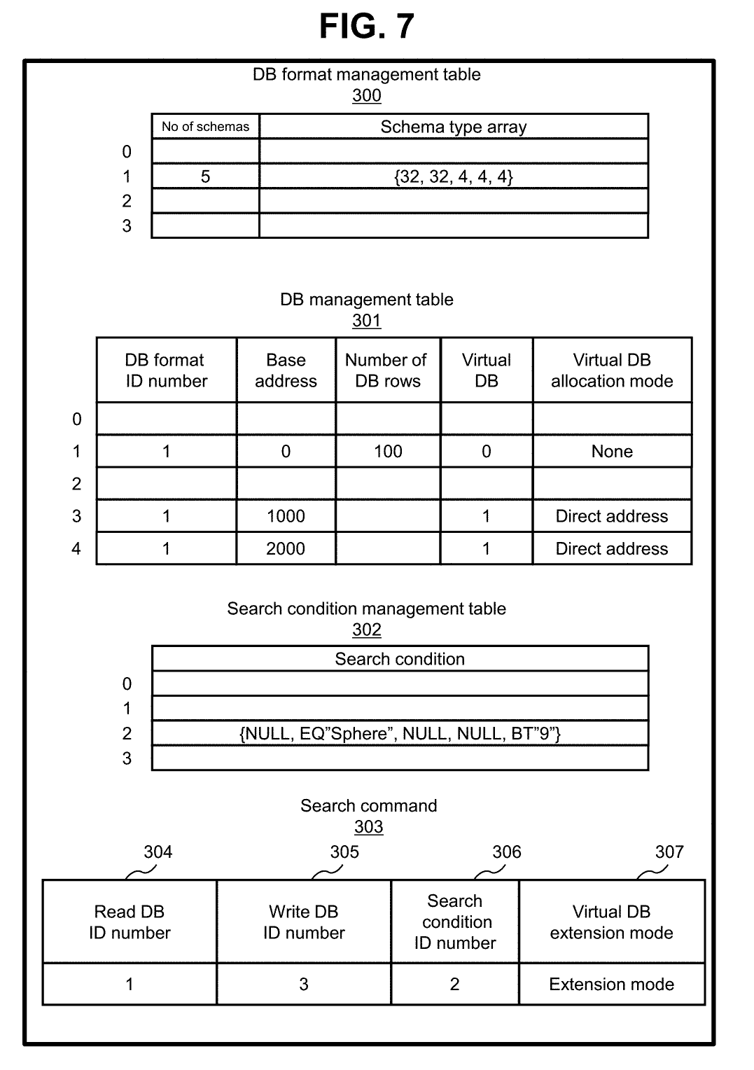

FIG. 7 illustrates a configuration example of constituent elements included in the DB search accelerator management information 252.

The DB search accelerator management information 252 includes a DB format management table 300, a DB management table 301, a search condition management table 302, and a search command 303.

The DB format management table 300 is a table which is configured according to a DB format instruction command and has an entry for each DB format identification number. The store information includes the number of schemas and a schema type array. The schema type array corresponds to a plurality of schemas and therefore retains values as an array.

The DB management table 301 is a table which is configured according to a DB pointer instruction command and a virtual DB allocation instruction command and has an entry for each DB identification number. The store information includes a DB format identification number for identifying a DB format, a base address in which the DB is stored, a number of DB rows which is the number of rows of the DB, a virtual DB indicating whether the DB is a whole DB (value 0) or a virtual DB (value 1) , and a virtual DB allocation mode which has a valid value when the DB is a virtual DB. The DB format identification number indicates the row number in the DB format management table 300. With the DB management table 301, it is possible to manage the structures and the storage locations of a plurality of databases defined in the storage 200.

The search condition management table 302 is a table which is configured according to a DB search condition instruction command and has an entry for each search condition identification number. The store information is a search condition array. Since the schema type array corresponds to a plurality of schemas, this value retains values as an array.

The search command 303 is configured according to a DB search instruction command (see FIG. 20) . The stored information includes a read DB identification number 304 indicating a search target DB, a write DB identification number 305 indicating a DB in which a search result is stored, a search condition identification number 306 indicating a search condition, and a virtual DB extension mode 307 indicating a method of extending a write destination DB indicated by the write DB identification number 305 during DB search. Numbers 304 and 305 indicate the row numbers in the DB management table 301. Due to this, for example, when the numbers 304 and 305 indicate “1,” a whole DB is a target DB. When the numbers 304 and 305 indicate “3” or “4,” a virtual DB is a target DB. Number 306 indicates a row number in the search condition management table 302. According to the example of FIG. 7, although the number 306 indicates “2,” this means that a condition described in the second row of the search condition management table 302 is designated as the search condition. When the upper limit of the virtual DB volume (for example, the upper limit of the number of address pointers) is designated as the virtual DB extension mode 307, for example, generation of the virtual DB may be successful if the volume of the generated virtual DB (for example, the number of address pointers) is equal to or less than the upper limit and the generation of the virtual DB may fail (error) if the volume of the generated virtual DB exceeds the upper limit. In this way, the volume of the generated virtual DB can be limited to be equal to or smaller than a desired volume. When the DB search instruction command is received, a DB search sequence is activated.

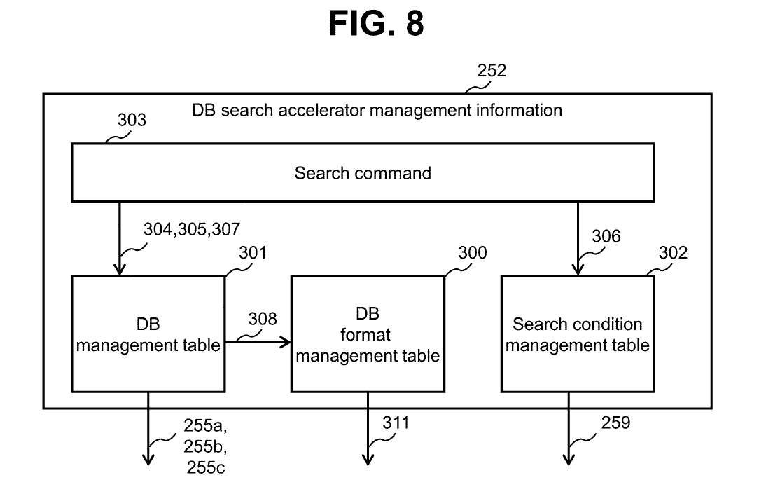

FIG. 8 illustrates an example of the relation between constituent elements of the DB search accelerator management information 252.

As described above, the DB search accelerator management information 252 includes the DB format management table 300, the DB management table 301, the search condition management table 302, and the search command 303.

The output of the DB search accelerator management information 252 includes read DB information 255a, write DB information 255b, DB operation-dedicated DB information 255c, schema information 311, and a search condition 259. The read DB information 255a is information on a read DB which is a DB corresponding to the read DB identification number 304 in the search command 303 (specifically, information specified using the number 304 as a key) (that is, the information in the DB management table 301). The write DB information 255b is information on a write DB which is a DB corresponding to the write DB identification number 305 in the search command 303 (specifically, information specified using the number 305 as a key) (that is, the information in the DB management table 301). The DB operation-dedicated DB information 255c is management information for operating the DB defined by the DB management table 301. The schema information 311 is information in a row (the row of the DB format management table 300) corresponding to the DB format identification number specified using the read DB identification number 304 as a key (that is, information indicating the number of schemas and the schema type array). The search condition 259 is information indicating a search condition in a row (the row in the search condition management table 302) specified using the search condition identification number 306 in the search command 303 as a key. The DB search accelerator management information 252 does not have a major function, and items of information 255a, 255b, 255c, 311, and 259 specified on the basis of the respective identification numbers in the search command 303 are output from the information 252. The read DB and the write DB correspond to either the whole DB or the virtual DB. Hereinafter, a read DB which is a whole DB can be referred to as a “read whole DB,” a read DB which is a virtual DB can be referred to as a “read virtual DB,” and the read whole DB and the read virtual DB can be collectively referred to as a “read DB.” Similarly, a write DB which is a whole DB can be referred to as a “write whole DB,” a write DB which is a virtual DB can be referred to as a “write virtual DB,” and the write whole DB and the write virtual DB can be collectively referred to as a “write DB.”

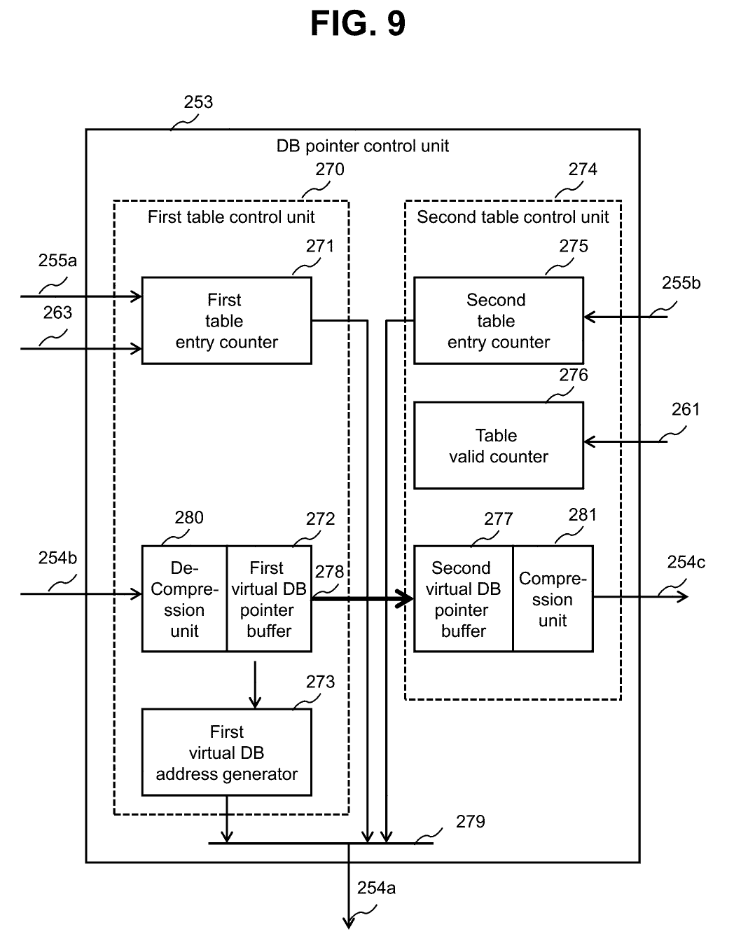

FIG. 9 illustrates a configuration example of the DB pointer control unit 253.

A basic function of the DB pointer control unit 253 includes a function of controlling generation of a read request to read data from a read DB, a function of controlling storing of an address pointer of a search hit DB row in a write virtual DB, and a function of controlling storing of the write virtual DB in the flash memory 242. The control of the read DB is performed by a first table control unit 270, and the control of the write DB is performed by a second table control unit 274.

The first table control unit 270 inputs the read DB information 255a to a first table entry counter 271 and acquires a base address in which the read DB is stored. When the read DB is a whole DB, the first table control unit 270 generates a read request to read data corresponding to the first data buffer 256 starting from the base address and issues the read request to the first internal bus interface 251 via a first selector 279 as a bus request 254a. Response data for this bus request 254a is returned via the first data buffer 256.

On the other hand, when the read DB is a virtual DB, first, the first table control unit 270 generates a bus request to read a group of address pointers of the virtual DB corresponding to a first virtual DB pointer buffer 272 starting from the base address and issues the bus request as a bus request 254a to the first internal bus interface 251. Response data 254b for this bus request 254a is stored in the first virtual DB pointer buffer 272 . When a virtual DB allocation mode in the read DB information 255a is a direct address compression mode, the data 254b is decompressed by a decompression unit 280, and the decompressed data is written to the first virtual DB pointer buffer 272. Decompression is not performed for the other virtual DB allocation modes. Subsequently, a first virtual DB address generator 273 generates a bus request 254a to read data corresponding to one row of the virtual DB to the first internal bus interface 251 via the first selector 279 using the virtual DB (the address pointer) stored in the first virtual DB pointer buffer 272. Similarly, response data for this bus request 254a is returned via the first data buffer 256.

As described above, although an address generation method used when the read DB is a whole DB is different from that used when the read DB is a virtual DB, the entity of the DB contents of the read DB is stored in the first data buffer 256 regardless of whether the read DB is the whole DB or the virtual DB. Moreover, when a read DB update request 263 generated by the first data buffer 256 is input to the first table entry counter 271, subsequent data is read again by the first data buffer 256. Due to this, a new bus request 254a for reading the data of the read DB or a group of address pointers of the virtual DB is issued. After that, depending on whether the read DB is a whole DB or a virtual DB, data read is sequentially performed repeatedly according to a read scheme corresponding to the DB type. In the description of the present embodiment, although the first virtual DB pointer buffer 272 is a single buffer (single face) , a scheme of performing read DB prediction which uses multiple buffers (multiple faces) such as a double buffer may be employed.

Next, an operation of the second table control unit 274 will be described. The write DB information 255b is input to the second table entry counter 275. Moreover, the search hit information 261 output by the DB search engine 257 is input to the table valid counter 276. The search hit information 261 is information indicating that a target row (row data of the read DB indicated by the first virtual DB pointer) is hit in the DB search process. Due to this, when the search hit information 261 is input, the second table control unit 274 stores address pointer information 278 of a target read DB hit row in the second virtual DB pointer buffer 277 and increments the table valid counter 276. When the volume of the second virtual DB pointer buffer 277 becomes identical to the volume of data written to the second virtual DB pointer buffer 277 (that is, the table valid counter 276 reaches the volume of the second virtual DB pointer buffer 277), the second table control unit 274 outputs the bus request 254a for writing the data in the second virtual DB pointer buffer 277 to the flash memory 242 via the first selector 279 starting from the base address (the base address of the write virtual DB) indicated by the second table entry counter 275. According to this bus request 254a, the virtual DB (the address pointer list) stored in the second virtual DB pointer buffer 277 is stored in the flash memory 242. When the second virtual DB pointer buffer is filled with data, the address pointer of the virtual DB is sequentially stored from an area subsequent to a previous storage address. In this way, the address pointer of the DB row which is hit in the DB search only is stored in the flash memory 242 as a new virtual DB. In the present embodiment, although the second virtual DB pointer buffer 277 is a single buffer (one face), performance can be improved by pipeline write (write to the flash memory 242) which uses multiple buffers (multiple faces) such as a double buffer.

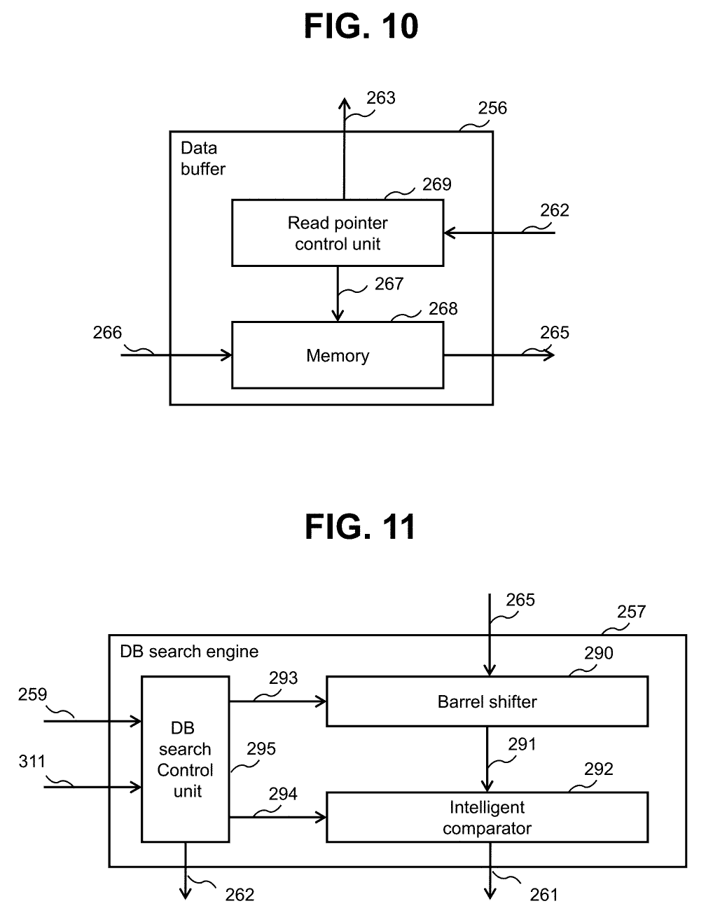

FIG. 10 illustrates a configuration example of the first data buffer 256.

The first data buffer 256 includes a memory 268 having a simple first-in first-out (FIFO) structure which receives internal bus data 266 which is the entity of DB contents of the read DB and a read pointer control unit 269 that performs read pointer control of the memory 268. DB row data 265 of the read DB is output from the memory 268 and the data 265 is transmitted to the DB search engine 257. Upon receiving a read DB row data acquisition request 262 output by the DB search engine 257, the read pointer control unit 269 sequentially increments the read pointer 267, reads the memory 268 using the read pointer 267, and outputs the read DB update request 263 to the DB pointer control unit 253 while bypassing the read DB row data acquisition request 262. As described above, a control method of the first data buffer 256 is simple FIFO control only.

FIG. 11 illustrates a configuration example of the DB search engine 257.

The DB search engine 257 searches for data that meets the search condition 259 from the read DB. When a search hit occurs, the DB search engine 257 outputs the search hit information 261 and returns the information 261 to the DB pointer control unit 253. The DB search engine 257 includes a DB search control unit 295 that controls the DB search engine 257, a barrel shifter 290 that performs a data shift process on the DB row data 265 of the read DB, and an intelligent comparator 292 that receives shift data 291 which is an output value of the barrel shifter 290 and outputs the search hit information 261. The intelligent comparator 292 is a comparator capable of verifying a plurality of search conditions, as exemplified by the search instruction query illustrated in FIG. 4, simultaneously. In order to perform this complex comparison, the DB search control unit 295 generates shift control 293 for controlling the barrel shifter 290 and comparison control 294 for controlling the intelligent comparator 292 on the basis of the search condition 259 and the schema information 311 to control the respective constituent elements. The shift control 293 and the comparison control 294 can be generated by combination decoding. The respective data rows of the read DB are sequentially provided as the DB row data 265 of the read DB according to the output of the read DB row data acquisition request 262.

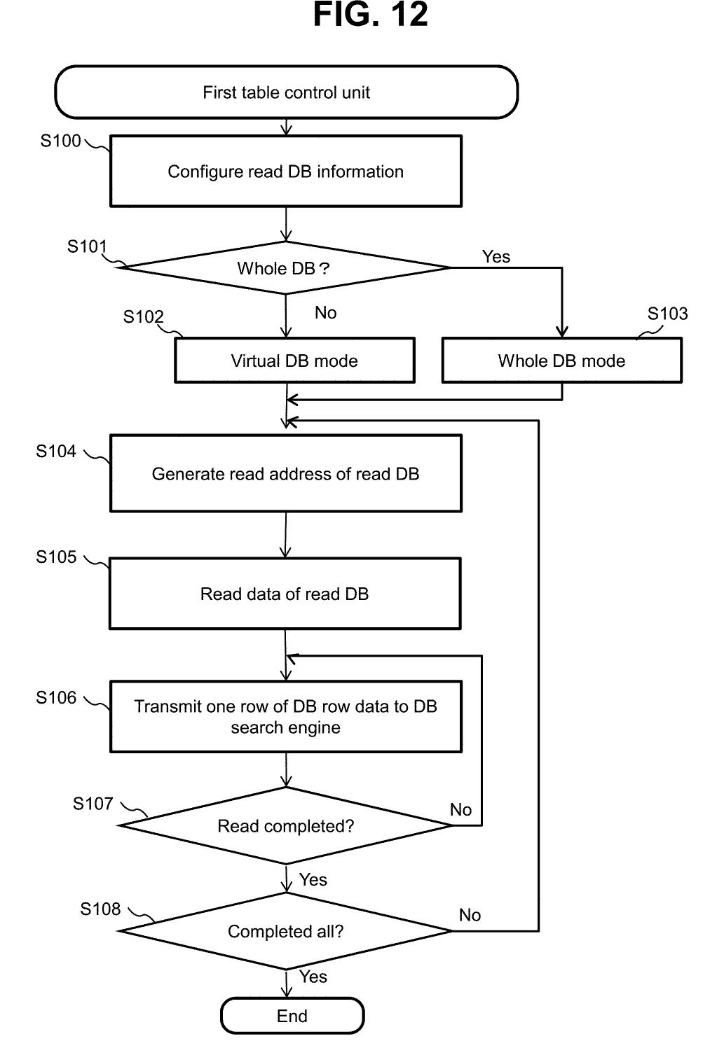

FIG. 12 illustrates an example of an operation flow of the first table control unit 270.

In S100, the first table control unit 270 stores the read DB information 255a indicated by the read DB identification number 304 in the search command 303 in the first table entry counter 271. The read DB information 255a is basic information such as the base address and the number of DB rows stored in the read DB and is information acquired from the DB management table 301.

In S101, the first table control unit 270 determines whether the read DB indicated by the target search command 303 is a whole DB or a virtual DB. A DB read mode corresponding to this determination result is executed.

In the normal mode, in S103, the first table control unit 270 sets a normal read mode as the DB read mode. On the other hand, in the virtual DB mode, in S102, the first table control unit 270 sets a virtual read mode as the DB read mode.

In S104, the first table control unit 270 stores a reference address in the first virtual DB pointer buffer 272 on the basis of a read DB referring scheme of the first table control unit 270 according to the set DB read mode. In S105, the first table control unit 270 issues the bus request 254a according to the address of the read DB stored in the first virtual DB pointer buffer 272 and finally stores the entity of the DB contents of the read DB in the first data buffer 256. In S106, the first table control unit 270 reads one row of DB row data 265 from the first data buffer 256 and transmits the read data 265 to the DB search engine 257. S106 is repeated until the amount of the row data read from the first data buffer 256 reaches the volume of the first data buffer 256 (S107) . Moreover, the processes subsequent to S104 are repeated until all items of row data of the read DB are read (S108).

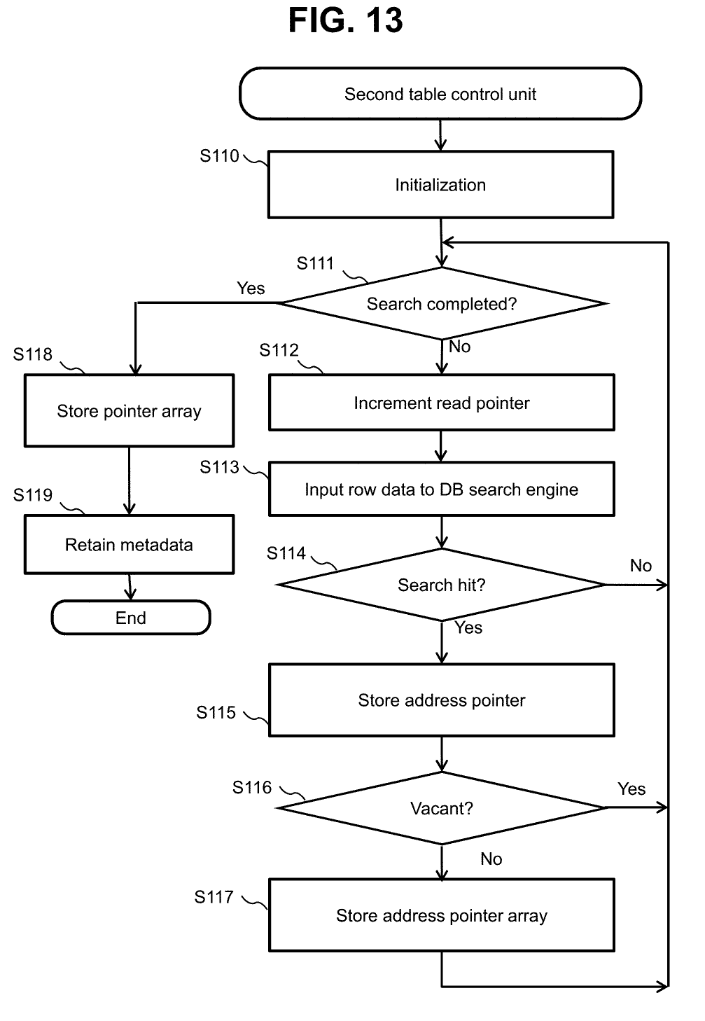

FIG. 13 illustrates an example of an operation flow of the second table control unit 274.

In S110, the second table control unit 274 initializes the second table entry counter 275, the table valid counter 276, and the second virtual DB pointer buffer 277. This is because valid data is not present in the write DB before a search process is performed. Initialization of the second table entry counter 275 means setting the base address of the write DB.

In S111, the second table control unit 274 determines whether search from all read DBs is completed.

When the determination result in S111 is negative, the second table control unit 274 increments the read pointer 267 in S112. In S113, the second table control unit 274 acquires the DB row data 265 of the read DB according to the read pointer 267 and inputs the data 265 to the DB search engine 257. In S114, the second table control unit 274 performs comparison on the DB row data 265 of the read DB under the search condition 259. When a search hit occurs, the second table control unit 274 stores the address pointer of the row data of the read DB in the second virtual DB pointer buffer 277 according to the virtual DB allocation mode of the write DB indicated by the DB management table 301 in S115. In S116, the second table control unit 274 determines whether a vacant area is present in the second virtual DB pointer buffer 277. When a vacant area is not present, the second table control unit 274 stores the generated address pointer array of the second virtual DB pointer buffer 277 in the flash memory 242 in S117.

When the determination result in S111 is positive (when search from all DBs is completed), the second table control unit 274 stores the address pointer of the write DB remaining in the second virtual DB pointer buffer 277 in the flash memory 242 in S118. In S119, the second table control unit 274 retains the metadata of the write DB. The metadata of the write DB is information including the information indicating the number of rows in the finally generated write DB.

The second table control unit 274 can return this metadata to the host server 100. In this way, the database search process ends.

According to the present embodiment, in a data search process, a data search result is stored in a virtual DB. In the present embodiment, the data volume of one row of a whole DB is 256 bytes. In the direct address mode, the same data can be represented using 36 bits. Due to this, the data volume of one row of the virtual DB is approximately 1/56 of the data volume of one row of the whole DB. For example, when the search result is generated as a new DB and the data volume of the DB (the search result) is reduced to ½ of the whole DB, approximately 1/110 of the data amount increases. In big data analysis, the data amount of a whole DB is generally very large, and the volume of the search result itself is large and reduces the remaining volume of the storage in the course of the DB search. Moreover, when a new DB is not created using the intermediate data in the course of DB search, it is necessary to search the entire DB again in second search and the processing amount is very large. Therefore, according to the present embodiment, it is possible to reduce the processing amount of the second and subsequent search processes by creating a DB using the search result and to reduce the added data amount even when the DB is created using the search result.

According to the present embodiment, the address pointers in the virtual DB are arranged in ascending order according to a search sequence. Moreover, in the second and subsequent search processes, a search range (search target) may be used as a virtual DB. Specifically, the storage 200 may only access data indicated by the virtual DB (address pointer list) within the whole DB with the aid of the DB search accelerator 250 upon receiving the DB search instruction command from the host server 100. According to such an access, a random read access to a storage medium in which the whole DB is stored is performed. According to the present embodiment, the storage medium is the flash memory 242 which is one type of storage medium capable of performing high-speed random access. Due to this, it is possible to accelerate search using the virtual DB.

Next, an operation of operating the virtual DB will be described. First, a virtual DB operation command of operating the virtual DB will be described.

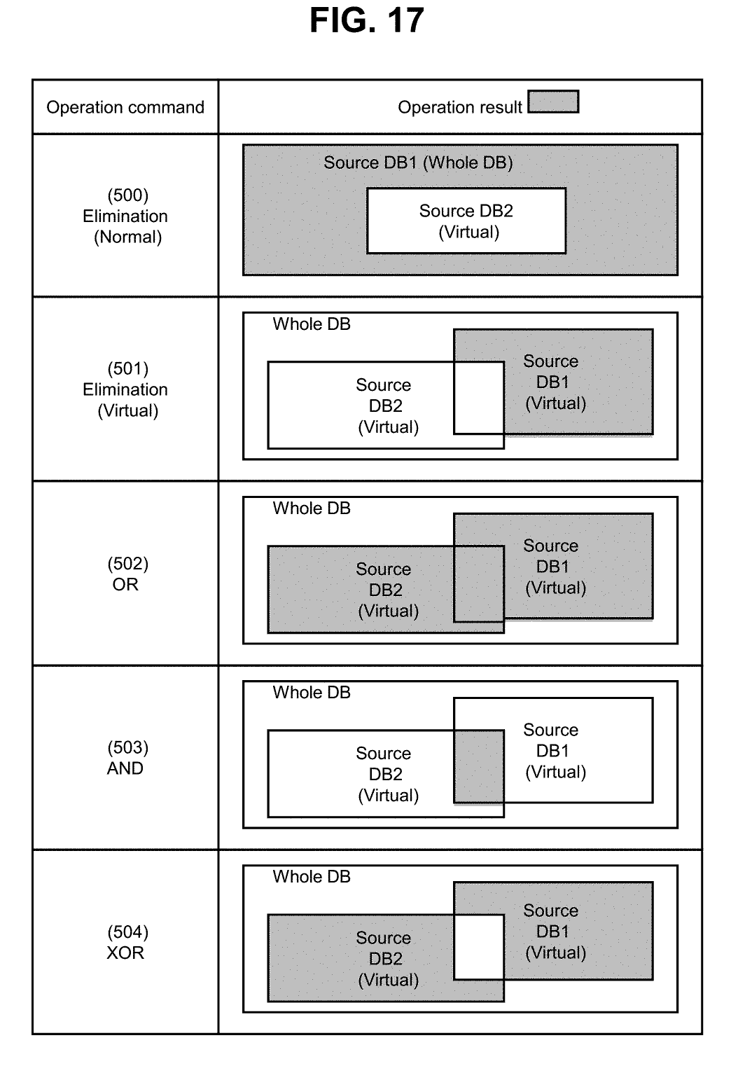

FIG. 21 illustrates an example of a DB operation command. FIG. 17 illustrates the concept of an example of the DB operation command. A gray area in FIG. 17 means that a virtual DB indicated by the gray area is generated.

A virtual DB OR command is a command to generate a virtual DB indicated by a write DB identification number by merging two virtual DBs indicated by read DB identification numbers 1 and 2 according to logical sum. This merge method reads respective DB row address pointers of two virtual DBs and combines, through monitoring, the address pointers so as to be arranged in ascending order whereby the merge result is stored in a new virtual DB indicated by the write DB identification number. The logical sum means storing DB row contents of any one of two virtual DBs are stored when the same DB row contents (address pointers) are present in the two virtual DBs. As a result, it is possible to avoid the same DB row contents from being stored redundantly. In this virtual DB OR command, the DB indicated by read DB identification number 1 and the DB indicated by read DB identification number 2 are virtual DBs. Therefore, in this logical sum-based merge, only the address pointers of the virtual DBs are merged, rather than merging the DB contents entities of the DBs (see the row indicated by reference numeral 502 in FIG. 17).

A DB elimination command is a command to generate a virtual DB indicated by a write DB identification number by eliminating a DB row in a virtual DB indicated by read DB identification number 2 from a DB row in a DB indicated by read DB identification number 1. The DB indicated by read DB identification number 1 may be either a whole DB or a virtual DB. Moreover, the DB indicated by read DB identification number 2 and the DB indicated by the write DB identification number are limited to a virtual DB. When the DB indicated by read DB identification number 1 is a whole DB, DB contents of an area of the whole DB excluding the virtual DB2 are generated (see the row indicated by reference numeral 500 in FIG. 17). Generally, source DB1 is a main DB and source DB2 is a noise DB, and an operation identical or similar to noise removal is performed. When the DB indicated by read DB identification number 1 is a virtual DB, source DB2 is regarded as noise and is eliminated from source DB1 as noise similarly to the above (see the row indicated by reference numeral 501 in FIG. 17). The above-described DB elimination command is used when eliminating the noise DB indicated by read DB identification number 2 from a base DB indicated by read DB identification number 1. Conversely, it is possible to generate a DB obtained by eliminating a virtual DB (the virtual DB indicated by read DB identification number 2) generated in the course of the database search from the base DB indicated by read DB identification number 1. In the former case, the new virtual DB itself generated by the DB elimination command can be regarded as valuable DB data by regarding the virtual DB generated in the course of the database search as noise. In the latter case, a virtual DB generated in the course of database search is regarded as a more valuable DB, and a new virtual DB generated by the DB elimination command can be moved to another low-cost storage area as less valuable data.

A virtual DB entitization command is a command to entitize a virtual DB. As described above, a virtual DB is not the DB contents entity of a database but is a list of address pointers to the DB contents entity. Therefore, it is possible to entitize a new DB by reading a DB contents entity from the address pointer of a virtual DB indicated by a read DB identification number and storing the DB contents entity in a database indicated by a write DB identification number. By this entitization, the host server 100 can refer to the virtual DB as in the case of a whole DB.

A virtual DB entity read command is a command to read a DB contents entity of a virtual DB indicated by a read DB identification number from the flash memory 242 using a group of address pointers thereof and returning the same to the host server 100. A basic process flow is equivalent to the virtual DB entitization command, and data is transferred to the host server using host return destination information instead of writing the same to the last flash memory 242.

Here, in the present embodiment, the storage medium of the storage 200 is the flash memory 242. A random read performance of the flash memory 242 is substantially equal to a sequential read performance and is sufficiently higher than HDD. Therefore, a data read performance by the virtual DB entity read command is high even in the case of a virtual DB in which the address pointers of the DB contents entities are random.

Although detailed commands are not illustrated in FIG. 21, in the present embodiment, one DB can be generated from two virtual DBs by AND (logical product) (reference numeral 503) or XOR (exclusive OR) (reference numeral 504) as illustrated in FIG. 17. Particularly, it is possible to enable DB operations to be realized by a virtual DB which is not made up of DB contents entities but address pointers of DB contents entities only, and to reduce a total DB volume when generating a snapshot of a DB, for example.

In the present embodiment, although the two DBs source DB1 and source DB2 are illustrated as the input in order to facilitate the description, three or more DBs may be input.

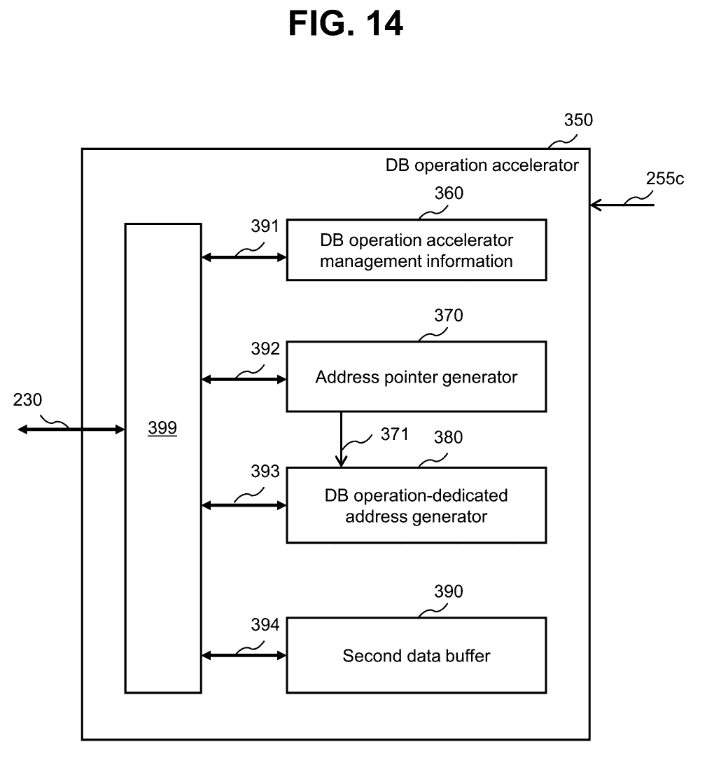

FIG. 14 illustrates a configuration example of the DB operation accelerator 350. In the present embodiment, although the DB operation accelerator 350 is a different constituent element from the DB search accelerator 250, these accelerators 350 and 250 may be integrated.

The DB operation accelerator 350 is one of constituent elements coupled to the internal bus 230 and controls commands related to operations of a virtual DB. The DB operation accelerator 350 includes a second internal bus interface 399, DB operation accelerator management information 360, an address pointer generator 370, a DB operation-dedicated address generator 380, and a second data buffer 390. The respective constituent elements and the second internal bus interface 399 perform communication as interfaces 391, 392, 393, and 394.

The second internal bus interface 399 is an interface coupled to the internal bus 230. The DB operation accelerator management information 360 includes information on a DB operation command. The address pointer generator 370 performs control on an address pointer of a DB row retained by a virtual DB. The DB operation-dedicated address generator 380 generates addresses for the DB operation accelerator 350 to access the internal bus 230. The second data buffer 390 retains a DB contents entity indicated by the address pointer retained by the virtual DB.

The DB operation accelerator 350 operates a DB defined by the DB management table 301. Due to this, DB operation-dedicated DB information 255c which is the management information thereof is input. Moreover, the address pointer generator 370 outputs a sixth virtual DB address pointer 371 retained by a fifth virtual DB pointer buffer 416 to be described later and inputs the same to the DB operation-dedicated address generator 380.

Moreover, the virtual DB operation command illustrated in FIG. 21 can be represented by three types of opcode and three types of operand of two read DB identification numbers and a write DB identification number. The DB operation accelerator management information 360 retains these items of information, selects DB management information indicated by the respective DB identification numbers, and performs control.

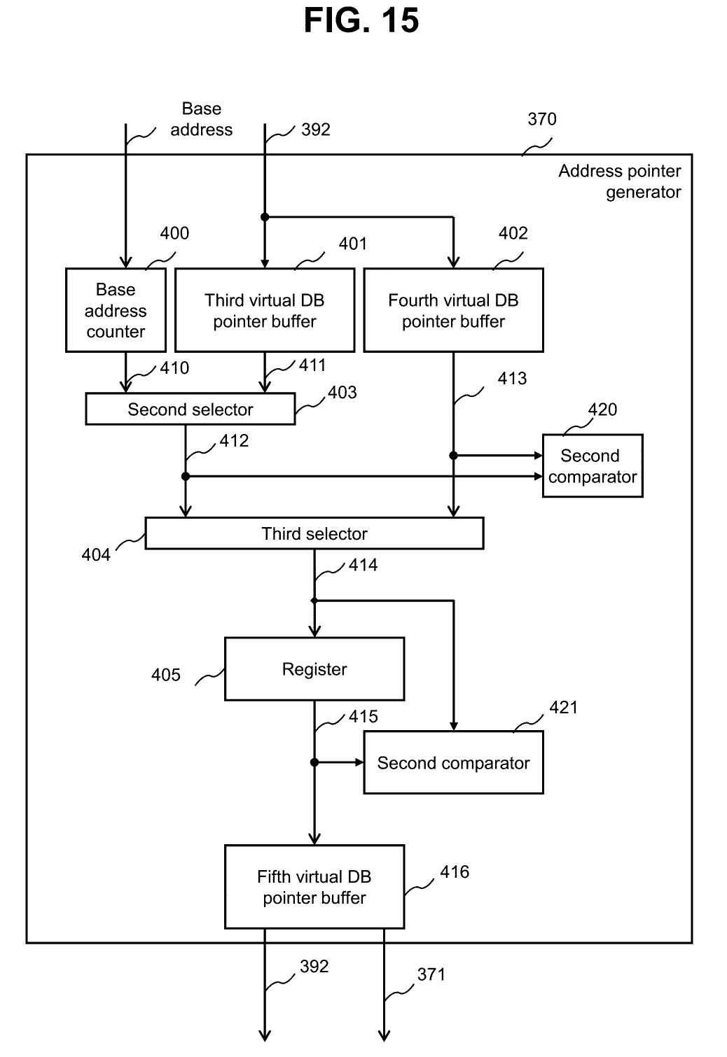

FIG. 15 illustrates a configuration example of the address pointer generator 370.

The address pointer generator 370 includes a base address counter 400, a third virtual DB pointer buffer 401, a fourth virtual DB pointer buffer 402, a second selector 403, a first comparator 420, a third selector 404, a register 405, a second comparator 421, and a fifth virtual DB pointer buffer 416.

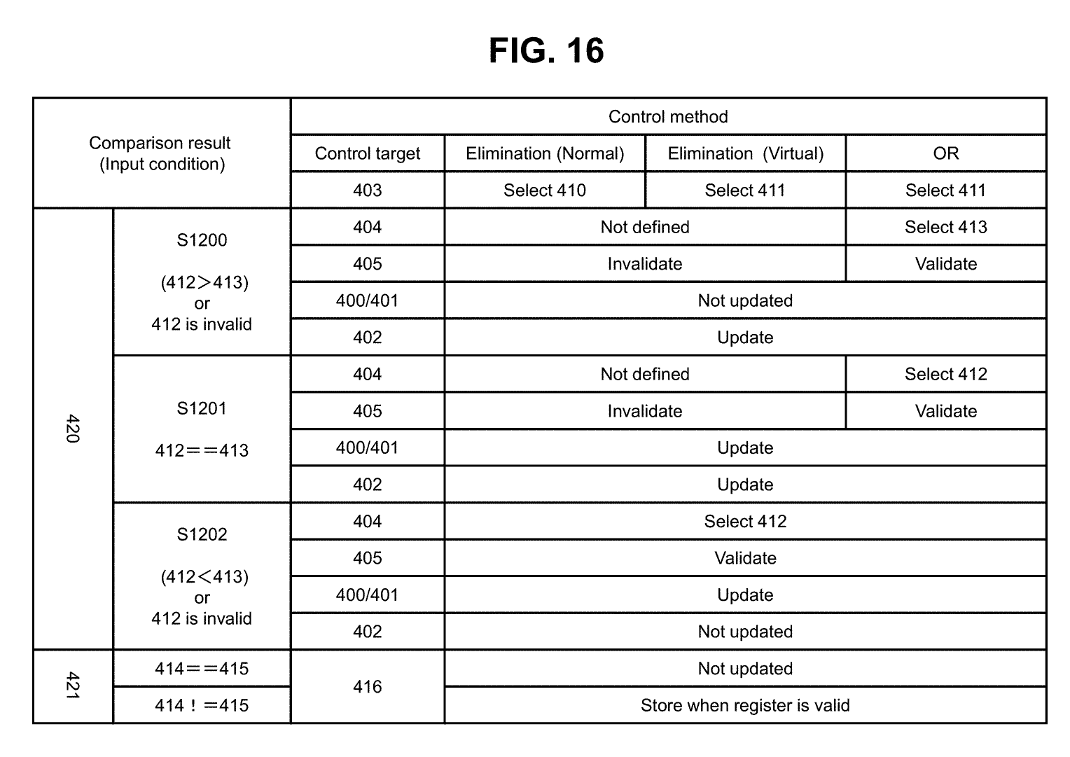

The base address counter 400 is a counter that manages addresses in which a DB contents entity of a whole DB is stored. In a DB elimination command, when a DB indicated by read DB identification number 1 is a whole DB, the base address of the whole DB is set to the base address counter 400. The base address counter 400 is incremented according to an instruction to be described later in FIG. 16 and sequentially generates a whole DB address pointer 410 in which the DB contents entity of the whole DB is stored. The third virtual DB pointer buffer 401 is a buffer that retains a group of address pointers retained by a virtual DB when the DB indicated by read DB identification number 1 is the virtual DB. The third virtual DB pointer buffer 401 is incremented according to an instruction to be described later in FIG. 16 and sequentially generates a first address pointer 411. The fourth virtual DB pointer buffer 402 is a buffer that retains a group of address pointers retained by a virtual DB indicated by read DB identification number 2. The fourth virtual DB pointer buffer 402 is incremented according to an instruction to be described later in FIG. 16 and sequentially generates a third virtual DB address pointer 413.

The second selector 403 selects the whole DB address pointer 410 and the first address pointer 411 and generates a second virtual DB address pointer 412. The third selector 404 selects the second virtual DB address pointer 412 and the third virtual DB address pointer 413 and generates a fourth virtual DB address pointer 414. The fourth virtual DB address pointer 414 is retained in the register 405 to generate a fifth virtual DB address pointer 415. The fifth virtual DB address pointer 415 is stored in a fifth virtual DB pointer buffer 416 according to an instruction to be described later. The address pointer stored in the fifth virtual DB pointer buffer 416 is an interface 392 to the second internal bus interface 399 and the sixth virtual DB address pointer 371 output to the DB operation-dedicated address generator 380.

The first comparator 420 compares the second virtual DB address pointer 412 and the third virtual DB address pointer 413. The second comparator 421 compares the fourth virtual DB address pointer 414 and the fifth virtual DB address pointer 415. The respective comparison results are used in the control to be described later.

FIG. 16 illustrates an example of the control of the address pointer generator 370. In the present embodiment, the DB contents entities of a virtual DB generated in the course of database search are arranged in ascending order. Due to this, in the present description, the feature of ascending arrangement is used.

This drawing illustrates the relation between the comparison results (input conditions) of the first and second comparators 420 and 421 and the control method of the third selector 404, the register 405, the base address counter 400, the third virtual DB pointer buffer 401, the fourth virtual DB pointer buffer 402, and the fifth virtual DB 416 in the virtual DB OR command and the DB elimination command. The second selector 403 is a selector that executes selection depending on a DB indicated by read DB identification number 1 which is one of operands is a whole DB or a virtual DB. The whole DB address pointer 410 to the whole DB is selected when the command is a whole DB elimination command.

First, an elimination command control method when the DB indicated by read DB identification number 1 is a whole DB will be described. According to the elimination command, a DB indicated by read DB identification number 2 is eliminated from a DB indicated by read DB identification number 1 to generate a virtual DB indicated by a write DB identification number. In the present description, it is assumed that the virtual DB indicated by read DB identification number 1 is source DB1, the DB indicated by read DB identification number 2 is source DB2, and the DB indicated by the write DB identification number is a write DB. Moreover, validation and invalidation of the register 405 indicates whether the register 405 is valid or invalid, and write determination of the fifth virtual DB pointer buffer 416 is performed when the register 405 is valid only.

In the first comparator 420, when the second virtual DB address pointer 412 is larger than the third virtual DB address pointer 413 (S1200), source DB1 is outside the range of source DB2. Due to this, the register 405 is invalid and the read pointer of the fourth virtual DB pointer buffer 402 is updated. As a result, the address pointer of source DB2 proceeds ahead.

When the process of S1200 is repeated, the second virtual DB address pointer 412 eventually becomes equivalent to the third virtual DB address pointer 413. When the second virtual DB address pointer 412 has become equivalent to the third virtual DB address pointer 413 (S1201), it is not necessary to store the DB row of source DB1 in the write DB according to the elimination command. Due to this, the register 405 is invalid, and the read pointers of the third and fourth virtual DB pointer buffers 401 and 402 are updated.

When the second virtual DB address pointer 412 is smaller than the third virtual DB address pointer 413 (S1202), it is necessary to retain a target row (the row data of source DB1 indicated by the second virtual DB pointer 412) of source DB1 in the write DB. Due to this, the third selector 404 selects the second virtual DB address pointer 412, the register 405 is valid, and the base address counter 400 is updated (incremented). Since the register 405 is valid, the pointer 415 in the register 405 is stored in the fifth virtual DB pointer buffer 416. In order to avoid storage of redundant data rows, the second comparator 421 stores the fifth virtual DB address pointer 415, while also updating a write pointer of the fourth virtual DB address pointer 414, only when the fourth virtual DB address pointer 414 is not equivalent to the fifth virtual DB address pointer 415.

By repeating S1200, S1201, and S1202, elimination is executed. When read of source DB1 ends (read of the second virtual DB address pointer ends), this process ends.

Next, an elimination command control method when the DB indicated by read DB identification number 1 is a virtual DB will be described. The control method has two differences from the control method when the DB indicated by read DB identification number 1 is the whole DB. One difference is that the second selector 403 selects the first virtual DB address pointer 411. The other difference is that the read pointer of the third virtual DB pointer buffer 401 instead of the base address counter 400 is updated. By this command, elimination can be executed on the virtual DB as well.

Next, a logical sum command control method will be described. In the logical sum command, source DB1 and source DB2 are virtual DBs. In the first comparator 420, when the second virtual DB address pointer 412 is larger than the third virtual DB address pointer 413 (S1200), the third selector 404 selects the third virtual DB address pointer 413 indicating source DB2, the register 405 is valid, and the read pointer of the fourth virtual DB pointer buffer 402 is updated. Moreover, both when the second virtual DB address pointer 412 has become equivalent to the third virtual DB address pointer 413 (S1201) , and the second virtual DB address pointer 412 is smaller than the third virtual DB address pointer 413 (S1202), the second virtual DB address pointer 412 is selected and the register 405 is valid. The update of the read pointers of the base address counter 400, the third virtual DB pointer buffer 401, and the fourth virtual DB pointer buffer 402, and the update of the write pointer of the fifth virtual DB address pointer 415 are similar to that of the elimination command.

Moreover, the DB entitization command involves reading a group of address pointers of a virtual DB indicated by a read DB identification number into the fifth virtual DB pointer buffer 416, reading DB contents entities from the flash memory 242 using the group of address pointers, and writing the same in the second data buffer 390. Lastly, the DB contents entities stored in the second data buffer 390 are written to the whole DB indicated by the write DB identification number using the base address.

An example of the control of the DB operation-dedicated address generator 380 will be described below.

When a command is a virtual DB OR command or a DB elimination command, the DB operation-dedicated address generator 380 reads a group of address pointers of source DB1 (virtual) indicated by read DB identification number 1 from the internal bus 230 into the third virtual DB pointer buffer 401 (when source DB1 is a whole DB, such read is not necessary). Moreover, the DB operation-dedicated address generator 380 reads a group of address pointers of source DB2 (virtual) indicated by read DB identification number 2 from the internal bus 230 into the third virtual DB pointer buffer 401. Moreover, the DB operation-dedicated address generator 380 writes a group of address pointers of a write DB indicated by a write DB identification number to the flash memory 242 via the internal bus 230 using the base address of the write DB.

When the command is a virtual DB entitization command, the DB operation-dedicated address generator 380 reads a group of address pointers of source DB1 (virtual) indicated by read DB identification number 1 from the internal bus 230 into the fifth virtual DB pointer buffer 416 (when source DB1 is a whole DB, such read is not necessary) . Moreover, the DB operation-dedicated address generator 380 reads the DB contents entities into the second data buffer 390 via the internal bus 230 using the group of address pointers stored in the fifth virtual DB pointer buffer 416. Furthermore, the DB operation-dedicated address generator 380 writes the DB contents entities stored in the data buffer 390 to the flash memory 242 via the internal bus 230 using the base address of the write DB indicated by the write DB identification number.

When the command is a virtual DB entity read command, the DB operation-dedicated address generator 380 reads a group of address pointers of source DB1 (virtual) indicated by read DB identification number 1 from the internal bus 230 into the fifth virtual DB pointer buffer 416 (when source DB1 is a whole DB, such read is not necessary) . Moreover, the DB operation-dedicated address generator 380 reads the DB contents entities into the second data buffer 390 via the internal bus 230 using the group of address pointers stored in the fifth virtual DB pointer buffer 416. Furthermore, the DB operation-dedicated address generator 380 returns the DB contents entities stored in the data buffer 390 to the host server 100 via the internal bus 230 using the host return destination information.

Hereinafter, the embodiment will be summarized. In the description of summary, new matters such as a modification of an embodiment may be added.

The storage 200 includes a host interface 201 that receives a command and the storage controller 106. The storage controller 106 searches for data, which meets a search condition specified on the basis of the received command, in a whole DB (a database as an entity) , generates a virtual DB which is a list of address pointers to the found data, and stores the generated virtual DB. Therefore, it is possible to reduce a processing amount of second and subsequent search processes by creating a DB using the search result and to reduce an added data amount even when the DB is created using the search result.

When a read source specified on the basis of the received command is a virtual DB, or when a virtual DB including a search result of the data that meets the specified search condition is present, the storage controller 106 determines whether data accessed using an address pointer in the virtual DB specified as the read source meets the specified search condition. In this way, the storage controller 106 can set the virtual DB as a search target (search range).

The storage 200 includes the flash memory 242 in which a whole DB is stored. The storage controller 106 accesses the flash memory 242 as a data access which uses the address pointer in the virtual DB specified as the read source. Although random read occurs in a search which uses the virtual DB as a search target, since the whole DB is present in a storage medium (a storage device) in which high-speed random read is possible as in the case of the flash memory 242, it is possible to accelerate search.

When a read source specified on the basis of the received command is a whole DB, or when a virtual DB including a search result of the data that meets the specified search condition is not present, the storage controller 106 searches for data that meets the specified search condition from the whole DB specified as the read source. In this way, the storage controller 106 can set the whole DB as a search target according to the content of the command or the presence of the virtual DB.

When a write destination specified on the basis of the received command indicates a virtual DB, or when a virtual DB including a search result of the data that meets the specified search condition is not present, the storage controller 106 generates the virtual DB which is a list of address pointers to the found data. In this way, the storage controller 106 can perform control on whether or not to generate a virtual DB according to the content of the command or the presence of the virtual DB.

When an upper limit of the volume of the virtual DB is specified on the basis of the received command, the storage controller 106 does not store the generated virtual DB in the flash memory 242 in which the whole DB is stored if the volume of the generated virtual DB exceeds the upper limit and stores the generated virtual DB in the flash memory 242 in which the whole DB is stored if the volume of the virtual DB is equal to or smaller than the upper limit. In this way, since the virtual DB is not stored in the flash memory 242 if the volume of the virtual DB exceeds the upper limit, it is possible to avoid a large reduction in volume of the flash memory 242.

The command designates either a whole DB or a virtual DB as a read source. The storage controller 106 selects a whole DB as a search target of the data that meets the search condition designated by the command if the read source designated in the command is the whole DB. The storage controller 106 selects a virtual DB as a search target of the data that meets the search condition designated by the command if the read source designated in the command is the virtual DB. In this way, the storage 200 can receive information on whether the search target is set to the whole DB or the virtual DB from the command.

The search condition designated in the command include a plurality of conditions. That is, a plurality of conditions can be simultaneously designated as the search condition.

The generated virtual DB has a format that follows a virtual DB allocation mode designated among two or more virtual DB allocation modes, the two or more virtual DB allocation modes being two or more from among:

(X) a direct address mode which is a mode in which address pointers themselves retained by a virtual DB are stored;

(Y) a direct address compression mode which is a mode in which a virtual DB compressed using difference values between address pointers adjacent in a virtual DB which is an arrangement of address pointers is stored; and

(Z) a bitmap mode which is a mode in which a bitmap made up of a plurality of bits corresponding respectively to a plurality of blocks that form address pointers of a virtual DB is stored for each address pointer.

In this way, it is possible to select the format of the virtual DB from the viewpoint of the magnitude of the volume of the virtual DB and the load of generating the virtual DB.

The storage controller 106 executes a logical operation in which a plurality of DBs including at least one virtual DB is input. As described above, examples of the logical operation include logical sum (OR), logical product (AND), elimination, and the like. In this way, it is possible to create new DBs which correspond to a plurality of different search conditions and in which redundant data is eliminated.

The plurality of DBs is a plurality of virtual DBs. The logical operation is a logical operation in which a plurality of address pointers of the plurality of virtual DBs is input. In this way, it is possible to create new DBs corresponding to a plurality of search conditions at high speed.

The plurality of DBs includes at least one virtual DB and at least one whole DB. New DBs corresponding to a plurality of search conditions can be created using at least a portion of the whole DB.

The storage controller 106 returns the generated virtual DB to the host server 100. The host interface 201 receives a read command, in which the address pointer of the virtual DB is designated as an address, from the host server 100. The storage controller 106 returns data read from the whole DB (the flash memory 242) using the address pointer designated by the received read command to the host server 100. In this way, when a virtual DB is created, the same result as the search result can be returned even when a normal read command is received from the host server 100.

While an embodiment has been described, the present invention is not limited to this embodiment, and various changed can naturally be made without departing from the spirit thereof.

For example, the generated virtual DB may be stored in a storage unit of the storage controller 106 and may be stored in the flash memory 242.

For example, the virtual DB is a virtual DB which is not made up of DB contents entities but address pointers only in which the DB contents entities are stored. An example of the virtual DB is made up of an 8 KB tag portion and an offset portion (or a 2-dimensional arrangement labeled in the bitmap portion) as described with reference to FIG. 5. Therefore, the virtual DB may be defined as a whole DB. Therefore, the host server 100 can allocate the virtual DB as a whole DB and access the virtual DB using a general IO command with respect to the storage 200. Moreover, it is possible to read the virtual DB into the host server 100 using the virtual DB entity read command and the host server 100 can operate this virtual DB itself made up of a group of address pointers like a normal process. Therefore, various database processes can be performed by a database search program (for example, the database software 120 executed by the host server 100) which uses a general IO command, a DB search command, and a DB operation command. That is, the host server 100 may also store the virtual DB. In this case, when the virtual DB is used as a search target, the host server 100 (for example, the CPU 110 that executes the database software 120) may transmit a read command in which the virtual DB (the address pointer list) is designated as an address to the storage 200. The storage controller 106 may return the data acquired from the address pointer list designated by the read command to the host server 100.

According to the above-described embodiment, the search command 303 is configured according to the DB search instruction command from the host server 100 and the search condition and the read DB are designated in the search command 303. Therefore, the storage controller 106 searches for the data, which meets the designated search condition, in the designated read DB. When the designated read DB is a virtual DB, the search range is the virtual DB. When the designated read DB is a whole DB, the search range is the whole DB (full search). Instead of such a scheme, for example, search control information including information which indicates whether a virtual DB corresponding to each search condition has been generated and information which indicates the correlation with a pointer to the already generated virtual DB may be stored in the storage unit of the storage controller 106. When the search condition is designated, the storage controller 106 may determine whether the virtual DB including the search result that meets the designated search condition has been generated by referring to the search control information using the designated search condition. When the determination result is positive, the storage controller 106 may use the virtual DB specified using the designated search condition as a search range. On the other hand, when the determination result is negative, the storage controller 106 may use the whole DB as a search range.

According to the above-described embodiment, the search command 303 is configured according to the DB search instruction command from the host server 100 and the write DB is designated in the search command 303. When the virtual DB is designated as the write DB, the virtual DB is generated. When the virtual DB is not designated as the write DB, the virtual DB is not generated. Instead of this, the write DB may not be designated, for example. Moreover, whenever a search process of searching for data that meets a designated search condition is performed, the storage controller 106 may always generate a virtual DB as a search result of the designated search condition if a virtual DB serving as a search range of the designated search condition is not present.

For example, at least one of the accelerators 250, 350, and 214 may not be present. A process that performs at least one of the accelerators 250, 350, and 214 may be performed by the built-in CPU 210. Specifically, for example, all of the processes performed by the storage controller 106 may be performed by the CPU 210 that executes a computer program. In this case, information included in at least one of the accelerators 250, 350, and 214 may be stored in the storage unit (for example, at least one of the DRAM 213 and the SRAM 211) of the storage controller 106.

### REFERENCE SIGNS LIST

100 Host server
200 Storage

1. A database search system comprising:
an interface configured to receive a command; and
a controller configured to search for data, which meets a search condition specified on the basis of the received command, in a whole database which is a database as an entity, generate a virtual database which is a list of address pointers to the found data, and store the generated virtual database.

2. The database search system according to claim 1, wherein
when a read source specified on the basis of the received command is a virtual database, or when a virtual database including a search result of data that meets the specified search condition is present, the controller is configured to determine whether data accessed using an address pointer in the virtual database specified as a read source meets the specified search condition.

3. The database search system according to claim 2, wherein
the interface is configured to receive a command from a host system,
the database search system further comprises a nonvolatile semiconductor memory in which the whole database is stored, and
the controller is a storage configured to access the nonvolatile semiconductor memory as a data access which uses an address pointer in the virtual database specified as a read source.

4. The database search system according to claim 3, wherein
when a read source specified on the basis of the received command is a whole database, or when a virtual database including a search result of data that meets the specified search condition is not present, the controller is configured to search for data, which meets the specified search condition, in the whole database specified as the read source.

5. The database search system according to claim 1, wherein
when a write destination specified on the basis of the received command indicates a virtual database, or when a virtual database including a search result of data that meets the specified search condition is not present, the controller is configured to generate the virtual database which is a list of address pointers to the found data.

6. The database search system according to claim 1, wherein
when an upper limit of a volume of the virtual database is specified on the basis of the received command, the controller is configured
not to store the generated virtual database in a storage device in which the whole database is stored if the volume of the generated virtual database exceeds the upper limit, and
to store the generated virtual database in a storage device in which the whole database is stored if the volume of the generated virtual database is equal to or smaller than the upper limit.

7. The database search system according to claim 1, wherein
the command is configured to designate either a whole database or a virtual database as a read source,
the controller is configured to
select a whole database as a search target of the data that meets the search condition designated in the command if the read source designated in the command is a whole database, and
select a virtual database as a search target of the data that meets the search condition designated in the command if the read source designated in the command is a virtual database.

8. The database search system according to claim 7, wherein
the search condition designated in the command includes a plurality of conditions.

9. The database search system according to claim 1, wherein
the generated virtual database has a format that follows a virtual DB allocation mode designated among two or more virtual DB allocation modes,
the two or more virtual DB allocation modes are two or more from among:
(X) a direct address mode which is a mode in which address pointers themselves retained by a virtual database are stored;
(Y) a direct address compression mode which is a mode in which a virtual database compressed using difference values between address pointers adjacent in a virtual database which is an arrangement of address pointers is stored; and
(Z) a bitmap mode which is a mode in which, for each address pointer of a virtual database, a bitmap made up of a plurality of bits corresponding respectively to a plurality of blocks that form the address pointer is stored.

10. The database search system according to claim 1, wherein
the controller is configured to execute a logical operation in which a plurality of databases including at least one virtual database is input.

11. The database search system according to claim 10, wherein
the plurality of databases is a plurality of virtual databases, and
the logical operation is a logical operation in which a plurality of address pointers of the plurality of virtual databases is input.

12. The database search system according to claim 10, wherein
the plurality of databases includes at least one virtual database and at least one whole database.

13. The database search system according to claim 1, wherein
the interface is configured to receive a command from a host system,
the controller is configured to return the generated virtual database to the host system,
the interface is configured to receive a read command, in which the address pointer of the virtual database is designated as an address, from the host system, and
the controller is configured to return data read using the address pointer designated by the received read command to the host system.

14. A database search method comprising:
receiving a command;
searching for data, which meets a search condition specified on the basis of the received command, in a whole database which is a database as an entity;
generating a virtual database which is a list of address pointers to the found data; and
storing the generated virtual database.
